(19) United States
(12) Patent Application Publication
(10) Pub. No.: US 2008/0172420 A1
(43) Pub. Date: Jul. 17, 2008

(54) Scoring Computer File Health

(76) Inventors: Rafal P. Konik, Oronoco, MN (US); Mark W. Theuer, Rochester, MN (US); Michael A. Venz, Rochester, MN (US)

Correspondence Address: IBM CORPORATION, 3605 HIGHWAY 52 NORTH, DEPT 917, ROCHESTER, MN, 55901-7829, US

(21) Appl. No.: 11/622,494

(22) Filed: Jan. 12, 2007

(51) Int. Cl. G06F 17/30

(52) U.S. Cl. 707/202; 707/E17.007

(57) ABSTRACT

A method, system and computer-readable medium are presented for scoring the health of a database file. In a preferred embodiment, the method includes the steps of: retrieving a plurality of file attributes from a file in a database; determining if at least one of the file attributes is damaged; and creating a health score for the file based on what percentage of the file attributes for the file are damaged.

### BACKGROUND OF THE INVENTION

1. Technical Field

The present disclosure relates in general to the field of data processing, and, in particular, to computers that utilize software files. Still more particularly, the present disclosure relates to scoring the health integrity of software files.

2. Description of the Related Art

At a high conceptual level, a computer can be understood as hardware that, under the control of an operating system, executes instructions that are in an application program. The application program manipulates data found in data files, which are persistently stored on devices such as hard disk drives. When the application is a database program, the files are known as “database files.” These database files are often maintained by a service provider and utilized by the service provider's customers.

Customers become frustrated when attempting to use a database file only to eventually discover that the database is damaged and cannot be used. A database file may be damaged because the definitional information of the file is corrupted. Alternatively, database files may have been corrupted a long time ago and the damage has remained hidden, only to suddenly surface through an interface that does not detect the damage but presents an odd assortment of information to the user. Examples of bizarre information surfacing are: Column headings in the format being overlaid with invalid data; Default Value structures being out of place; and/or a Structured Query Language (SQL) alias (long name) disappearing from the column/field definition. This corruption can be due to part of a file being damaged and disappearing, hardware problems causing partial information to be saved on a disk, or software problems resulting in bits and bytes being modified when they should not.

### SUMMARY OF THE INVENTION

To address the problems described above associated with corrupted database files, the present invention presents a method, system and computer-readable medium for scoring the health of a database file. In a preferred embodiment, the method includes the steps of: retrieving a plurality of file attributes from a file in a database; determining if at least one of the file attributes is damaged; and creating a health score for the file based on what percentage of the file attributes for the file are damaged.

The above, as well as additional, purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1A-B is a flow-chart of exemplary steps taken to create and utilize a health score for a database; and

FIG. 2 depicts an exemplary database file server in which the steps illustrated in FIGS. 1A-B may be implemented.

### DETAILED DESCRIPTION OF THE PREFERRED EMBODIMENT

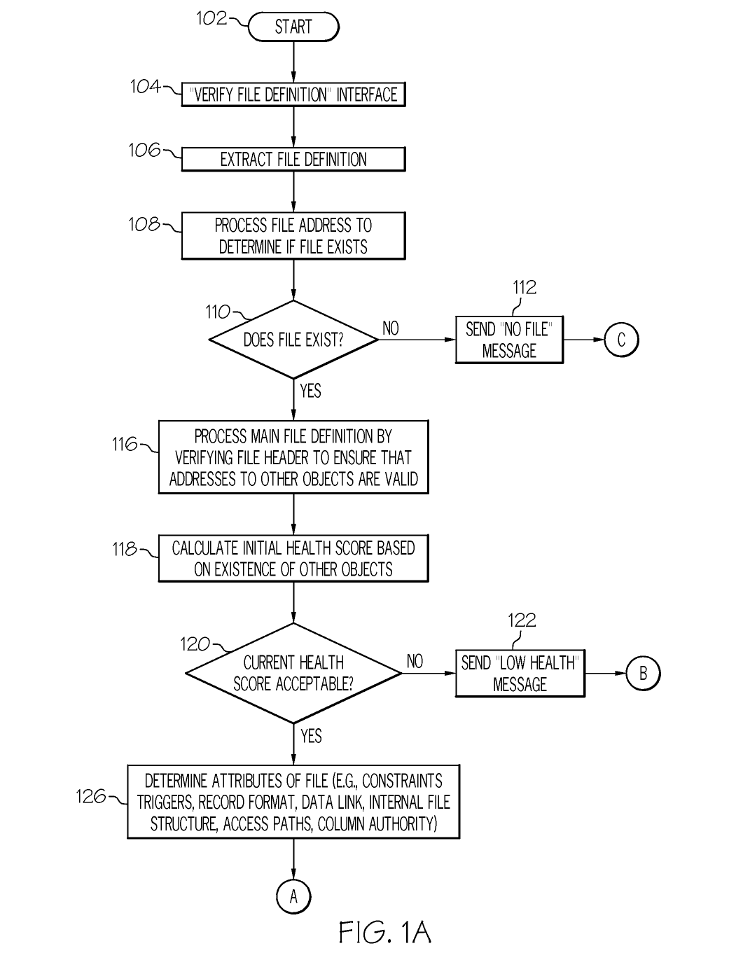

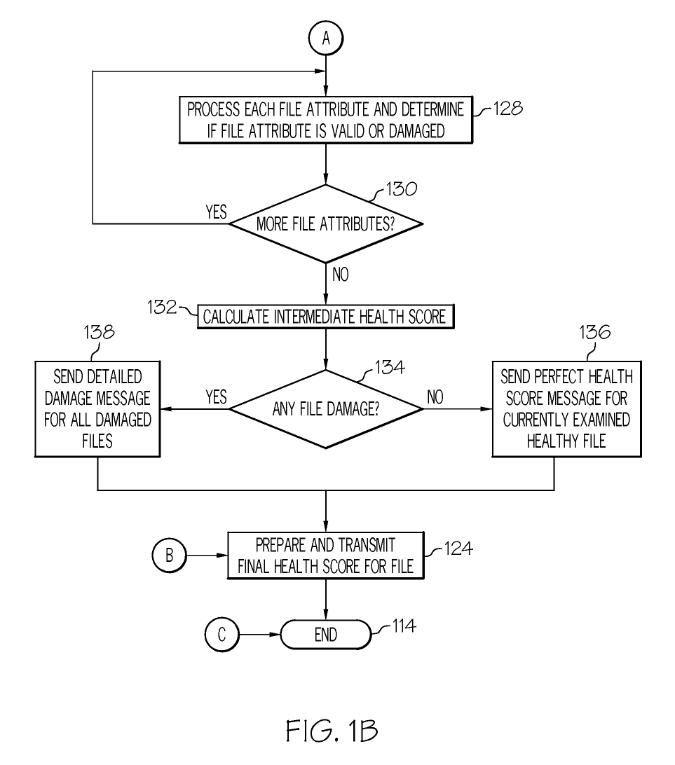

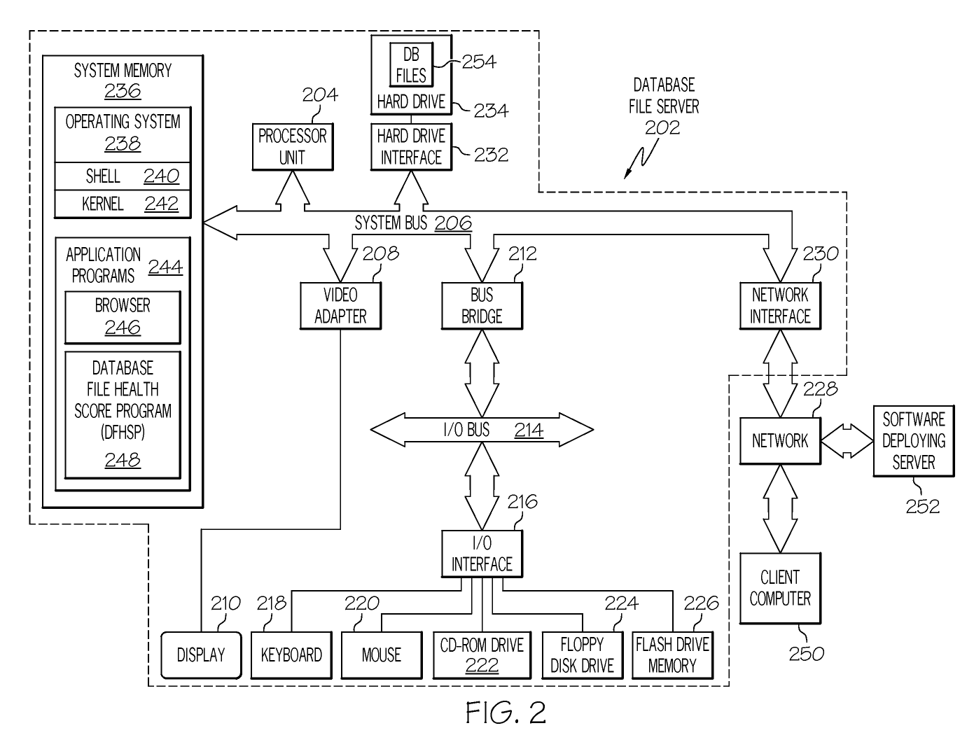

With reference now to the figures, and in particular to FIG. 1A-B, a flow-chart of exemplary steps taken to create a health score for a database file is presented. The process begins at initiator block 102, which may be instigated by scheduled maintenance of a database, a user's decision to evaluate the health of a database, or any other similar prompting event/decision. As described in block 104, a file definition interface for a database is initiated. That is, the file definition interface is initially executed and prepared to extract the file definition (block 106). The file definition describes the nature of the database, including what types of software applications can utilize the database, the size of the database, the address of the database, etc. Data content at the file address, which may be a virtual or a physical memory address, is then examined to confirm that the database file actually exists (block 108). If the database file does not exist (query block 110), then a “No File” message (block 112) is generated and transmitted, preferably to a system administrator, user, or a software application such as a Database File Health Score Program, depicted below in FIG. 2 as DFHSP 248, and the process ends (terminator block 114).

If the database file DOES exist (again at query block 110), then the file definition is processed by verifying that a file header of the file definition shows valid addresses to other objects that can be called to or from the database (block 116). This permits an initial health score (block 118) to be calculated. If there are too many invalid pointers (or addresses) to other objects in the main file definition, then the health score of the database is not acceptable (query block 120), and a “Low Health” message (block 122) is sent to DFHSP 248 for preparation of a final health score for the database file (block 124).

However, if the health score determined in block 118 is acceptable, then attributes of the database file are determined (block 126). Each file attribute is then processed to determine if that file attribute is valid or damaged (block 128). Attributes that are examined include, but are not limited to, the following ten attributes.

1. Addressability to Composite objects.

The database file is a composite object that can be used by multiple applications. To access the database, the applications must be able to read the following various information in the file attributes. In an exemplary database file such as the IBM® iSeries™ database file, these addressability attributes include, but are not limited to, the File Control Block (FCB), the File Constraint Space (FCS), the Trigger Definition Space (TDS), the Record Format (FMT), the Column Extension Space (CES), file directories, Member (MBR) name, Data Space, Indexes and associated space, and Group Space (GRPSPC).

FCB is defined as a file system structure that describes the attributes of the database file. Information in the FCB includes the name of the drive from which the database file was retrieved, the file name, the file type, implementation dependent (variable) information and record numbers.

FCS, TDS, and FMT are defined as internal parameters that are needed to call an Application Program Interface (API) that is used to access the database file.

CES, file directories, Data Space, Indexes and associated space, and GRPSPC are defined as various parameters that describe the structure, size and naming of files in the database.

MBR is defined as including the cursor and the Open Data Path (ODP). A member is one of several different sets of data, each having a same format, within the database file. The cursor is a controls structure that points to a row of data in the database file. The ODP is a control block that exists only when a file is open, and contains information about merged file attributes and information returned by input or output operations to the database file.

### 2. Offsets

Offsets describe a number of measuring units from an arbitrary starting point in the database file to some other point in the database file. The offsets are evaluated to ensure that they actually point to some other point in the database file, and are not so large that they point to an address outside the database file. Furthermore, the offsets are evaluated to ensure that they do not go beyond the maximum Machine Interface (MI) object size. The maximum MI defines the size of the object that the offset is allowed to traverse. If an offset attempts to point too far up or down within an object, then the offset is deemed corrupt.

### 3. Name Structures

The names of objects (files, columns, formats, etc.) in the database file are evaluated for correctness and validity. That is, the names are evaluated to ensure that they are in the proper nomenclature format, and that they do not violate naming protocol (e.g., using a prohibited name, etc.).

### 4. Lengths of Data

The data in the database files are evaluated to ensure that they do not exceed their maximum allowed length, or, alternatively, do not meet their required minimum length. Data that is “too long”, or “too short” is assumed to be corrupted.

### 5. Bit Patterns/Attributes

Different files may have distinct bit patterns, or attributes. For example, a physical file cannot have join file information. If a physical file has such attributes, then it is assumed to be in conflict, and thus invalid.

### 6. Pointers/Addresses

Pointers and addresses are examined to ensure that they are not NULL (no value) or contain addresses of destroyed (“erased”) data objects.

### 7. Systems Licensed Internal Code (SLIC) Damage

An SLIC database includes a dataspace object to actually hold data, cursors to point to the dataspace object for reading the data, and dataspace indexes that are used for lookups against entries in a directory. If any of these components are damaged, the SLIC database is unhealthy to some degree.

### 8. Constraints

Constraints are essential requirements of a database file, including an object from which a unique resource set can be inherited. Constraints are evaluated to ensure compatibility between the SLIC database structure, the FCS, and data in a system's cross reference files.

### 9. Triggers

Triggers are defined as code that causes a trigger application, which accesses the database files, to execute. Triggers are evaluated to ensure that 1) the trigger application exists and 2) that the trigger application matches a trigger definition in the TDS.

### 10. Data Link Information

Data Link information must exist in the Data Link File Manager (DLFM) for a file with FILE LINK CONTROL.

Referring again to FIG. 1B, once all file attributes are evaluated for damage (query block 130), an intermediate Health Score is calculated (block 132). This Health Score will range from 0% to 100% for the ratio of failing tests to total number of samplings. For example, if 50 file attributes were examined, and two fail, the Health Score would be 96% with a Fail Ratio of 2/50. The worst possible Health Score would be 0% and the best possible Health Score would be 100%.

Besides a raw pass/fail score, each failed file attribute will be returned with additional data for evaluation/correction purposes. This data will include:
1. File object type (e.g., FMT and the system pointer/address)
2. Problem Area (e.g., a missing data object, NULL pointers, corrupted offsets, etc.)
3. Target Structure Information (e.g., FMT and/or Field (FLD) name)
4. Specific problem information address (i.e., the pointer/address or offset to the problem datafile)
5. Specific problem data (i.e., the actual data that is corrupted, if available)

If there is not any file attribute corruption at all (query block 134), then a “perfect health” score message is sent (block 136) to an evaluation program, such as DFHSP 248 shown in FIG. 2. Otherwise, a damage message (block 138) is sent to the DFHSP 248, including the detailed data just described (i.e., file object type, problem area, target structure information, problem address, problem data). In either case, a final report is generated by the DFHSP 248 (block 124), and sent to a system administrator for further action.

With reference now to FIG. 2, there is depicted a block diagram of an exemplary database file server 202, in which the present invention may be utilized. Database file server 202 includes a processor unit 204 that is coupled to a system bus 206. A video adapter 208, which drives/supports a display 210, is also coupled to system bus 206. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Database file server 202 is able to communicate with a client computer 250 via a network 228 using a network interface 230, which is coupled to system bus 206. Network 228 may be an external network such as the Internet, or an internal network such as an Ethernet or a Virtual Private Network (VPN). Client computer 250 requests and utilizes database files 254, which are stored in the hard drive 234 of the database file server 202, from database file server 202.

A hard drive interface 232 is also coupled to system bus 206. Hard drive interface 232 interfaces with the hard drive 234, which, as described above, stores the database files 254 that are the subject of the database file scoring described above.

In a preferred embodiment, hard drive 234 populates a system memory 236, which is also coupled to system bus 206. System memory is defined as a lowest level of volatile memory in database file server 202. This volatile memory includes additional higher levels of volatile memory (not shown), including, but not limited to, cache memory, registers and buffers. Data that populates system memory 236 includes database file server 202's operating system (OS) 238 and application programs 244.

OS 238 includes a shell 240, for providing transparent user access to resources such as application programs 244. Generally, shell 240 is a program that provides an interpreter and an interface between the user and the operating system. More specifically, shell 240 executes commands that are entered into a command line user interface or from a file. Thus, shell 240 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 242) for processing. Note that while shell 240 is a text-based, line-oriented user interface, the present invention will equally well support other user interface modes, such as graphical, voice, gestural, etc.

As depicted, OS 238 also includes kernel 242, which includes lower levels of functionality for OS 238, including providing essential services required by other parts of OS 238 and application programs 244, including memory management, process and task management, disk management, and mouse and keyboard management.

Application programs 244 include a browser 246. Browser 246 includes program modules and instructions enabling a World Wide Web (WWW) client (i.e., database file server 202) to send and receive network messages to the Internet using HyperText Transfer Protocol (HTTP) messaging, thus enabling communication with client computer 250. In one embodiment of the present invention, client computer 250 and software deploying server 252 may each utilize a same or substantially similar architecture as shown and described for database file server 202.

Also stored with system memory 236 is a Database File Health Score Program (DFHSP) 248, which includes some or all software code needed to perform the steps described in FIG. 1A-B. DFHSP 248 may be deployed from software deploying server 252 to database file server 202 in any automatic or requested manner, including being deployed to database file server 202 in an on-demand basis.

The hardware elements depicted in database file server 202 are not intended to be exhaustive, but rather are representative to highlight essential components required by the present invention. For instance, database file server 202 may include alternate memory storage devices such as magnetic cassettes, Digital Versatile Disks (DVDs), Bernoulli cartridges, and the like. These and other variations are intended to be within the spirit and scope of the present invention.

Note further that, in a preferred embodiment of the present invention, software deploying server 252 performs all of the functions associated with the present invention (including execution of DFHSP 248), thus freeing database file server 202 from having to use its own internal computing resources to execute DFHSP 248.

It is to be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), and communication media, such as computer and telephone networks including Ethernet, the Internet, wireless networks, and like network systems. It should be understood, therefore, that such signal-bearing media, including but not limited to tangible computer-readable media, when carrying or encoded with a computer program having computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, in one embodiment, the present invention may be implemented through the use of a computer-readable medium encoded with a computer program that, when executed, performs the inventive steps described and claimed herein.

The current disclosure thus presents a computer-implemented method, system and computer-readable medium for health scoring a database file. In a preferred embodiment, the method includes the steps of: retrieving a plurality of file attributes from a file in a database; determining if at least one of the file attributes is damaged; and creating a health score for the file based on what percentage of the file attributes for the file are damaged. In one embodiment, at least one of the file attributes is an addressability attribute, which includes a File Control Block (FCB) and a Member (MBR), wherein the MBR includes a cursor and an Open Data Path (ODP). In another embodiment, at least one of the file attributes an offset that points to a descendent object of the file, wherein the offset is limited to a pre-determined maximum Machine Interface (MI). In another embodiment, the method further includes the steps of extracting a file address from a file definition interface to determine if the file exists; and processing a main file definition to ensure that addresses to other objects called by the file are valid.

When the method is implemented by execution of computer-executable instructions stored on the computer-readable medium, the computer executable instructions are deployable from a software deploying server to a database file server that is at a remote location, preferably in an on-demand basis.

While the invention has been particularly shown and described with reference to a preferred embodiment, it will be understood by those skilled in the art that various changes in form and detail may be made therein without departing from the spirit and scope of the invention.

What is claimed is:

1. A method for health scoring a database file, the method comprising:
retrieving a plurality of file attributes from a file in a database;
determining if at least one of the file attributes is damaged; and
creating a health score for the file based on what percentage of the file attributes for the file are damaged.

2. The method of claim 1, wherein at least one of the file attributes is an addressability attribute.

3. The method of claim 2, wherein the addressability attribute includes a File Control Block (FCB) and a Member (MBR), wherein the MBR includes a cursor and at least one attribute selected from a group consisting of an Open Data Path (ODP), a File Constraint Space (FCS), a Trigger Definition Space (TDS), a Record Format (FMT), a Column Extension Space (CES), and a Group Space (GRPSPC).

4. The method of claim 1, wherein at least one of the file attributes is an offset/pointer that points to a dependent object of the file.

5. The method of claim 4, wherein the offset is limited to a pre-determined maximum Machine Interface (MI), wherein the maximum MI defines the size of the object that the offset is allowed to traverse.

6. The method of claim 1, further comprising:
extracting a file address from a file definition interface to determine if the file exists; and
processing a main file definition to ensure that addresses to other objects called by the file are valid.

7. A system comprising:
a processor;
a data bus coupled to the processor;
a memory coupled to the data bus; and
a computer-usable medium embodying computer program code, the computer program code comprising instructions executable by the processor and configured for:
retrieving a plurality of file attributes from a file in a database;
determining if at least one of the file attributes is damaged; and
creating a health score for the file based on what percentage of the file attributes for the file are damaged.

8. The system of claim 7, wherein at least one of the file attributes is an addressability attribute.

9. The system of claim 8, wherein the addressability attribute includes a File Control Block (FCB) and a Member (MBR), wherein the MBR includes a cursor and at least one attribute selected from a group consisting of an Open Data Path (ODP), a File Constraint Space (FCS), a Trigger Definition Space (TDS), a Record Format (FMT), a Column Extension Space (CES), and a Group Space (GRPSPC).

10. The system of claim 7, wherein at least one of the file attributes is an offset that points to a dependent object of the file.

11. The system of claim 10, wherein the offset is limited to a pre-determined maximum Machine Interface (MI), wherein the maximum MI defines the size of the object that the offset is allowed to traverse.

12. The system of claim 7, wherein the instructions are further configured for:
extracting a file address from a file definition interface to determine if the file exists; and
processing a main file definition to ensure that addresses to other objects called by the file are valid.

13. A computer-readable medium encoded with computer program code for sharing kindred registry data between an older version of a configuration file and a newer version of a configuration file, the computer program code comprising computer executable instructions configured for:
retrieving a plurality of file attributes from a file in a database;
determining if at least one of the file attributes is damaged; and
creating a health score for the file based on what percentage of the file attributes for the file are damaged.

14. The computer-readable medium of claim 13, wherein at least one of the file attributes is an addressability attribute.

15. The computer-readable medium of claim 14, wherein the addressability attribute includes a File Control Block (FCB) and a Member (MBR), wherein the MBR includes a cursor and at least one attribute selected from a group consisting of an Open Data Path (ODP), a File Constraint Space (FCS), a Trigger Definition Space (TDS), a Record Format (FMT), a Column Extension Space (CES), and a Group Space (GRPSPC).

16. The computer-readable medium of claim 13, wherein at least one of the file attributes is an offset that points to a dependent object of the file.

17. The computer-readable medium of claim 16, wherein the offset is limited to a pre-determined maximum Machine Interface (MI), wherein the maximum MI defines the size of the object that the offset is allowed to traverse.

18. The computer-readable medium of claim 13, wherein the computer executable instructions are further configured for:
extracting a file address from a file definition interface to determine if the file exists; and
processing a main file definition to ensure that addresses to other objects called by the file are valid.

19. The computer-readable medium of claim 13, wherein the computer executable instructions are deployable from a software deploying server to a database file server that is at a remote location.

20. The computer-readable medium of claim 13, wherein the computer executable instructions are provided by a software deploying server to a database file server in an on-demand basis.
